(19) United States
(12) Patent Application Publication
(10) Pub. No.: US 2017/0109413 A1
(43) Pub. Date: Apr. 20, 2017

(54) Search System and Method for Updating a Scoring Model of Search Results based on a Normalized CTR

(71) Applicant: Quixey, Inc., Mountain View, CA (US)

(72) Inventors: Nina GHOLAMI, Los Gatos, CA (US); Dinesh MISHRA, San Jose, CA (US); Manoj JOSHI, San Jose, CA (US)

(21) Appl. No.: 15/294,609

(22) Filed: Oct. 14, 2016

Related U.S. Application Data
(60) Provisional application No. 62/241,461, filed on Oct. 14, 2015.

(51) Int. Cl. G06F 17/30

(52) U.S. Cl. CPC G06F 17/30554; G06F 17/3053; G06F 17/30536

(57) ABSTRACT

A system is provided and includes search, analytics acquisition, CTR, and scoring modules. The search module: receives query requests from one or more user devices for respective queries; and based on the query requests and a CTR-based scoring model, conducts searches to provide search results for the queries. The analytics acquisition module acquires analytics data corresponding to the queries. The analytics data includes query files for the queries and selection files for the queries for which a selection event occurred. At least some of the selection events occur when a user of the one or more user devices selects a search result item in the search results provided for the queries. The CTR module determines a normalized CTR based on the analytics data. The scoring module updates the CTR-based scoring model based on the normalized CTR. The search module conducts a search based on the updated CTR-based scoring model.

### CROSS-REFERENCE TO RELATED APPLICATIONS

This application claims the benefit of U.S. Provisional Application No. 62/241,461, filed Oct. 14, 2015. The entire disclosure of the application referenced above is incorporated herein by reference.

### FIELD

The present disclosure relates to search metrics determined based on user device search activity.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A search engine refers to software executed to conduct a search for information, documents, programs, etc. Keywords are typically provided by a user to a network device. The network device then transmits the keywords to a server of a service provider. The server conducts a search and provides search results back to the user.

Click-through rate (CTR) is a search metric that is traditionally calculated to measure user engagement with search results. As an example, a user device can generate a query request, which is provided to a search server. The search server conducts a search based on the query request and provides search results to the user device. The search results may include a list of (i) documents, (ii) links, and/or (iii) titles of application programs (referred to herein as “applications” or “APPs”). A user then selects (or clicks on) one or more of the search result documents, links, and APPs. APPs are provided if the query request is initiated, for example, at an application store. An application store refers to a window opened by an executed program and that displays and offers access to the APPs. Mobile devices often have access to an application store, where APPs can be purchased and/or downloaded.

### SUMMARY

A system is provided and includes a search module, an analytics acquisition module, a CTR module and a scoring module. The search module is configured to (i) receive query requests from one or more user devices for respective queries, and (ii) based on the query requests and a CTR-based scoring model, conduct searches to provide search results for each of the queries. The analytics acquisition module is configured to acquire analytics data corresponding to the queries, where the analytics data includes (i) query files for the respective queries, and (ii) one or more selection files for each of the queries for which a selection event occurred, and where at least some of the selection events occur when a user of the one or more user devices selects a search result item in the search results provided for the queries. The CTR module is configured to determine a normalized CTR based on the analytics data. The scoring module is configured to update the CTR-based scoring model based on the normalized CTR. The search module is configured to, subsequent to the searches, conduct a search based on the updated CTR-based scoring model.

In other features, the search module is configured to (i) assign search identifiers to the queries and corresponding search results, and (ii) transmit the search results of the queries and the search identifiers to the one or more user devices. The CTR module is configured to (i) based on the search identifiers, group the selection files corresponding to the queries, and (ii) determine the normalized CTR based on, for each of the queries, a number of user selections of search result items provided in the corresponding search results.

In other features, the system further includes an assignment module configured to assign synthetic search identifiers to the query files and the selection files of the queries based on timestamps of the query files and the selection files. The CTR module is configured to (i) based on the synthetic search identifiers, group the selection files corresponding to the queries, and (ii) determine the normalized CTR based on, for each of the queries, a number of user selections of search result items provided in the corresponding search results. In other features, the selection events occur when a user of the one or more user devices provides a user input or click subsequent to one of the queries and prior to a next query after the one of the queries. The assignment module is configured to: determine whether the selection events are valid selection events, where an evaluated selection event is determined to be a valid selection event if the evaluated selection event has not occurred more than a predetermined amount of time after a timestamp of (i) a corresponding one of the query requests, (ii) a corresponding one of the query files, or (iii) another selection event; and assign the synthetic search identifiers to the valid selection events and not to invalid selection events.

In yet other features, the CTR module is configured to normalize a number of selections of search result items per query to 0 or 1. In other features, the CTR module is configured to determine a non-normalized CTR, and the scoring module is configured to update the CTR-based scoring model based on the non-normalized CTR. In other features, the system further includes at least one server including the search module, the analytics module, the CTR module and the scoring module.

In other features, the system further includes: a search server including the search module and the scoring module; and an analytics server including the analytics acquisition module and the CTR module. In other features, the CTR module is configured to determine the normalized CTR based on (i) a number of normalized selections of search result items provided in the search results of the queries, and (ii) a total number of queries.

In still other features, a user device is provided and includes: an input device configured to receive a first query request from a user; an application search module configured to (i) generate a first query file including the first query request, (ii) transmit the first query file to a search server, and (ii) based on the first query file, receive from the search server a response signal including search results; a development module configured to, based on a state of a timer, generate selection files in response to user inputs provided subsequent to the application search module receiving the search results and prior to a second query request, where each of the selection files includes (i) a timestamp of one of the user inputs or clicks, or (ii) a search identifier provided in the response signal, and where the development module refrains from generating a selection file when a predetermined time of the timer has lapsed; and an analytics module configured to update analytics data of the user device based on information in the first query file and the selection files, and transmit the analytics data to an analytics server to update a normalized click-through-rate-based scoring model.

In other features, the development module is configured to generate a second query file including at least one of (i) the search identifier, or (ii) a timestamp of the query request or the first query file. The analytics module is configured to update the analytics data based on information in the second query file. In other features, each of the selection files includes a timestamp of when one of the user inputs is received at the user device. In other features, each of the selection files includes the search identifier provided in the response signal.

In other features, the development module is configured to, based on the state of the timer, generate the selection files in response to respective selections by the user of search result items provided in the search results. Each of the selection files includes a timestamp of one of the selections.

In other features, a method is provided and includes: receiving query requests from one or more user devices for respective queries; and based on the query requests and a click-through-rate (CTR)-based scoring model, conducting searches to provide search results for each of the queries; acquiring analytics data corresponding to the queries, where the analytics data includes (i) query files for the respective queries, and (ii) one or more selection files for each of the queries for which a selection event occurred, and where at least some of the selection events occur when a user of the one or more user devices selects a search result item in the search results provided for the queries. The method further includes: determining a normalized CTR based on the analytics data; updating the CTR-based scoring model based on the normalized CTR; and conducting a search, subsequent to the searches, based on the updated CTR-based scoring model.

In yet other features, the method further includes: assigning search identifiers to the queries and corresponding search results; transmitting the search results of the queries and the search identifiers to the one or more user devices; based on the search identifiers, grouping the selection files corresponding to the queries; and determining the normalized CTR based on, for each of the queries, a number of user selections of search result items provided in the corresponding search results.

In other features, the method further includes: assigning synthetic search identifiers to the query files and the selection files of the queries based on timestamps of the query files and the selection files; based on the synthetic search identifiers, grouping the selection files corresponding to the queries; and determining the normalized CTR based on, for each of the queries, a number of user selections of search result items provided in the corresponding search results.

In still other features, the method further includes: determining whether the selection events are valid selection events, where the selection events occur when a user of the one or more user devices provides a user input or click subsequent to one of the queries and prior to a next query after the one of the queries, and where an evaluated selection event is determined to be a valid selection event if the evaluated selection event has not occurred more than a predetermined amount of time after a timestamp of (i) a corresponding one of the query requests, (ii) a corresponding one of the query files, or (iii) another selection event; and assigning the synthetic search identifiers to the valid selection events and not to invalid selection events.

In other features, the method further includes: normalizing a number of selections of search result items per query to 0 or 1; and determining the normalized CTR based on (i) the normalized number of selections of search result items per query, and (ii) a total number of queries.

In other features, the method further includes: determining a non-normalized CTR; and updating the CTR-based scoring model based on the non-normalized CTR.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The details of one or more examples are set forth in the accompanying drawings and the description below. Other features, objects, and advantages will be apparent from the description and drawings, and from the claims.

FIG. 1 is a functional block diagram of an example of a search system including a CTR-based scoring module and a normalized CTR module in accordance with the present disclosure.

FIG. 2 is a functional block diagram illustrating examples of a user device, a search server, an analytics server, and a partner server of the search system of FIG. 1.

FIG. 3 is a functional block diagram illustrating certain operating aspects of the search system of FIG. 1 including query file generation, selection file generation, and analytics data generation and transfer in accordance with the present disclosure.

FIG. 4 is a functional block diagram of certain operating aspects of the search system of FIG. 1 including synthetic search identifier (SSID) assigning, search metric generating, and CTR-based scoring model updating in accordance with the present disclosure.

FIG. 5 illustrates an example method of operating a user device including generating query files and selection files in accordance with the present disclosure.

FIG. 6 illustrates an example method of operating a search server including providing search results, generating search IDs (SIDs) and updating the CTR-based scoring model in accordance with the present disclosure.

FIG. 7 illustrates an example method of operating an analytics server including assigning SSIDs to queries and selection events, normalizing queries, and determining search metrics in accordance with the present disclosure.

FIG. 8 illustrates an example method of operating a partner server including transferring files and generating SIDS in accordance with the present disclosure.

FIG. 9 illustrates an example set of data including search queries (Q) and selection events (S).

### DETAILED DESCRIPTION

Traditionally, a CTR is calculated as a total number of clicks TC divided by a total number of searches (or queries) TQ and is represented as a percentage, as shown by equation 1. A click refers to a selection of one of multiple search engine result page (SERP) impressions provided as part of a search result list on a SERP. Each SERP impression may be linked to a document, a site, an APP and/or other search result item. The selection may be provided by a user placing a cursor over a SERP impression and pressing a button on a mouse, thereby providing a “click.”

$$CTR = \frac{TC}{TQ} \qquad ( 1 )$$

The traditional method for calculating a CTR is limited and thus is not a reliable indicator of overall user engagement in results provided by a search APP. An example of a search APP is an APP store, which allows users to search, select, review, purchase, and/or download APPs. A user may initiate multiple searches at a user device. The user device generates query requests for the searches and in response receives search results for each of the query requests. As an example, if 10 queries are conducted and there are 2 clicks per query, then the CTR is 200%. As another example, if 10 queries are conducted and the user clicks 10 times on results associated with only one of the queries, the CTR is 10/10 or 100%. This holds true although no clicks were provided for results from 9 of the queries. For the example provided, the CTR of 100% is not a reliable indicator of user engagement since the user had no engagement with over a majority of the query results. The CTR may not be a reliable indicator of user engagement across multiple searches because heavier engagement (e.g., a large number of clicks) with results of some queries may outweigh light/no engagement (e.g., 0 or a small number of clicks) with results of other queries.

A search system is provided that includes generation of search metrics including normalized CTRs, which provide a reliable indicator of overall user engagement with results of queries. The search metrics may include traditional CTRs (TCTRs) and normalized CTRs (NCTRs). The search metrics are used to update and improve search performance of the search system. This includes updating a CTR-based scoring model used to provide search results.

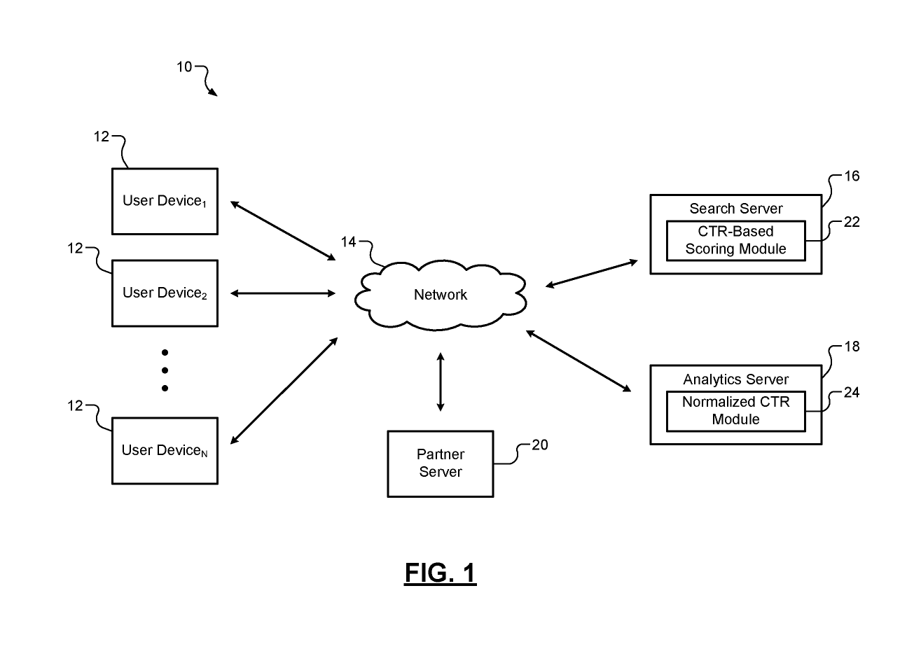

FIG. 1 shows a search system 10 that includes user devices 12, a network 14, a search server 16, an analytics server 18 and a partner server 20. The search server 16 includes a CTR-based scoring module 22. The analytics server 18 includes a normalized CTR module 24. During operation, the user devices 12 generate query requests. The search server 16 performs searches based on the query requests to provide search results to the user devices 12. The normalized CTR module 24 determines normalized CTRs based on analytics data corresponding to the query requests and search results to provide an indication of user engagement with the search results. The CTR-based scoring module 22 updates a CTR-based scoring model based on the normalized CTRs. The CTR-based scoring model is used when conducting searches to provide and rank search results. The CTR-based scoring model and the normalized CTRs are further described below.

Each of the user devices may be a mobile device, a cellular phone, a tablet, a computer, a wearable device, or other network device. The network 14 may include various types of networks, such as a local area network (LAN), a wide area network (WAN), and/or the Internet. The network 14 may include input/output (I/O) components, such as network interface controllers, repeaters, bridges, switches, routers, and firewalls.

Although shown as separate servers, the servers 16, 18 may be implemented as a single server that includes both of the modules 22, 24. Although a certain number of each of the servers 16, 18 and 20 are shown, any number of each of the servers 16, 18, 20 may be included in the search system 10. The partner server 20 may be implemented as shown or may be implemented (i) between one or more of the user devices 12 and the network 14, or (ii) between the network 14 and one or more of the servers 16, 18. The partner server 20 may (i) operate as a router and transfer files, data and IDs and/or other information between the user devices 12 and the servers 16, 18, (ii) perform operations normally performed by one or more of the servers 16, 18, and/or (iii) may supplement and/or perform additional operations not performed by the servers 16, 18.

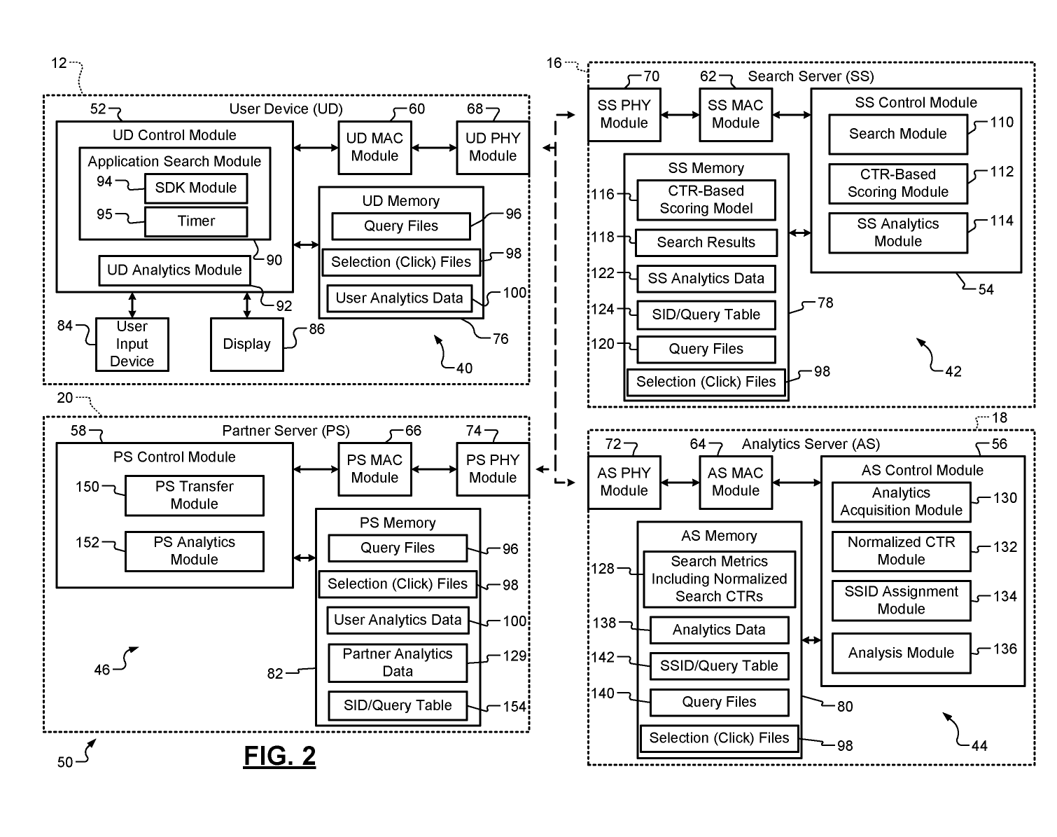

FIG. 2 shows a portion 50 of the search system 10 of FIG. 1 including one of the user devices 12, the search server 16, the analytics server 18, and the partner server 20. Each of the user device 12, search server 16, analytics server 18, and partner server 20 includes respective operating systems 40, 42, 44, 46, which include respective control modules 52, 54, 56, 58, medium access control (MAC) modules 60, 62, 64, 66, physical layer (PHY) modules 68, 70, 72, 74 and memories 76, 78, 80, 82. The user device 12 may also include a user input device 84 and a display 86. The MAC modules 60, 62, 64, 66 refer to MAC layers and transfer data between the control modules 52, 54, 56, 58 and the PHY modules 68, 70, 72, 74. The PHY modules 68, 70, 72, 74 communicate with each other. Data is transmitted between the PHY modules 68, 70, 72, 74. This may be accomplished via the network 14 of FIG. 1.

The user device (UD) control module 53 may include an application search module 90 and a UD analytics module 92. The application search module 90 controls generation of query requests based on user inputs received from the user input device 84 and/or the display 86, which may perform as a user input device. The user input device 84 may include input/output (I/O) components including hardware and software that is configured to communicate with various human interface devices, such as display screens, a keyboard, a pointer device (e.g., a mouse), a touchscreen, a touchpad, a microphone, and/or other user input device. In an embodiment, the I/O components may include hardware and software that is configured to communicate with additional devices, such as external memory (e.g., external HDDs). The display 86 displays, for example, a front-end of a search engine and search results provided by conducted searches. The display 86 may also display a front-end of an APP store.

The application search module 90 includes a standard development kit (SDK) module 94, which generates “call back” signals including query files 96 and/or selection (or click) files 98. Although the transfer of query information and selection information is primarily described herein as being provided in query files and selection files, the query information and selection information may be provided in corresponding frames, packets and/or signals. A query file may include keywords provided for a search, a user ID, a unique user device ID (e.g., an international mobile station equipment identity (IMEI)), a timestamp of when a corresponding query request was generated, and/or other query related information. A selection file may include a selection ID, a user ID, a unique user device ID (e.g., the IMEI), a timestamp of when a corresponding selection was made, and/or other selection related information. The call back signals may be generated at predetermined time periods (e.g., during a search session, at the end of a search session, once a day, once a week, once a month, etc.). A search session refers to a period during which a query request is generated, search results for the search request are provided, and a user is clicking on and reviewing the search results. Each of the query files and selection files may include a search ID as is further described below. The query files and selection files may be provided to and stored in one or more of the server 16, 18, 20.

The UD analytics module 92 may track user analytics data 100 and provide the user analytics data to one or more of the servers 16, 18, 20 at predetermined time periods (e.g., during a search session, at the end of a search session, once a day, once a week, once a month, etc.). This may be done automatically by the UD control module 52 and/or based on request signals received from the servers 16, 18, 20. In an embodiment, the user analytics data includes: a geographical location of a user and/or a user device; a time period during which a user and/or a user device is conducting a query; habits and/or trends of a user when conducting a query; types of queries likely to be performed by a user and/or a user device; etc. One or more of the servers 16, 18, 20 may be provided with, track and/or store the user analytics data, which may include analytics data specific to a user and/or specific to a user device. One or more of the servers 16, 18, 20 may track and store aggregated analytics data associated with users and/or user devices, such as: how many users are inputting query requests; how many user devices are transmitting queries; an average age group of each type of query; time period during which each type of query is be conducted; etc. The UD analytics module 92 may also control the types of information sent back to the servers 16, 18, 20 and when the user analytics data is sent to the servers 16, 18, 20 (e.g., whether the data is sent when available, in batches, and/or upon request). The UD analytics module 92 may collect user analytics data from search applications (e.g., native applications) and/or based on web-based searches.

As an example, the servers 16, 18 may be configured to: receive query requests as part of respective query files (sometimes referred to as query wrappers); transmit search results; perform operations on analytics data; gather data, documents, and APPs from sources; and index and store the data, documents and APPs. The search server 16 includes the operating (or search) system 42, which implements searches based on received query requests. The search server (SS) control module 54 may include a search module 110, a CTR-based scoring module 112, and an SS analytics module 114. The search module 110 receives query requests and conducts searches based on a CTR-based scoring model 116 to provide search results 118. The search module 110 may generate query files 120 corresponding to the conducted searches. The query files 120 may include keywords provided for a search, a user ID, an IMEI, a timestamp of when a corresponding query request was generated, a timestamp when a search was conducted, a search ID, and/or other query related information. The search server 16 may generate and assign search IDs (SIDS) to the search requests. The CTR-based scoring module 112 updates the CTR-based scoring model 116.

The CTR-based scoring model 116 is a relevance model that is used to score search results. The score assigned to each search result item in the search results may be referred to as a “result score.” The result scores may indicate the relevance of the search result item to queries. For example, high result scores may indicate more relevant search result items. The CTR-based scoring module may rank search result items based on the result scores assigned to the search result items. The UD control module 52 may render the search results as part of a SERP shown on the display 86. The search result items are shown in an order that is based on the result scores.

The CTR-based scoring model may refer to an algorithm implemented by the search server 16 to score individual search results, where the result scores may indicate the relevance of the search results to a query and other user context parameters (e.g., a geographical location of the user device 12, an operating system of the user device 12, a type of the user device 12, etc.). In an embodiment, the CTR-based scoring model 116 includes one or more machine learning models (e.g., a supervised learning model) configured to receive the search metrics 128. The one or more machine-learned models may generate the result scores based on the search metrics 128. The machine learning models may include a machine learning regression model that has a set of decision trees (e.g., gradient boosted decision trees). In one embodiment, the CTR-based scoring model 116 includes a gradient boosted tree having: (i) SERP impressions, documents, links, APPs, and/or other search result items; and (ii) relevant scores of each search result item. As another example, the machine-learning regression model may include a logistic probability formula. The machine learning may include a semi-supervised learning task, where a minority of training data is labeled with human-curated scores and a remainder of the training data is used and/or labeled without human intervention.

The CTR-based scoring model 116 can be updated over time. In one embodiment, the CTR-based scoring model 116 is updated by a search system operator. In other embodiments, the CTR-based scoring module 112 updates the CTR-based scoring model 116 automatically. The updates may be based on a number of changed search metrics and/or magnitudes of the changes in the search metrics). For example, the CTR-based scoring module 112 may update the CTR-based scoring model 116 based on a reduction in an NCTR and/or a widening of a gap between a TCTR and an NCTR. Updating the CTR-based scoring model 116 may include updating search documents, links, and/or APPs included in search data and/or an APP store, which may be displayed on the display 86.

The SS analytics module 114 tracks and aggregates query analytics data and search analytics data (collectively referred to as SS analytics data 122). The query analytics data is related to a query conducted and may include, for example, a search ID, a timestamp of the search request, the query request, and aggregation data. The aggregation data may include: a type of the user device that generated the search request; a number of queries generated by each user device; geographical locations of each user device; partner servers associated with each user device; times of day that query requests are generated; etc. The results analytics data is related to the search results and may include a search ID, a timestamp of the search request and aggregate data, such as: a number of results provided for each query conducted; a number of search results provided for a geographical area of one or more user devices; an amount of time a user spent engaging with search results; sums and/or averages of different parameters; etc.

The SS memory 78 may store the CTR-based scoring model 116, the search results 118, the query files 120, and the SS analytics data 122. The query files 120 may include the query files 96 generated by the user device 12. The search server 16 may receive the query files 96 and/or the selection files 98 generated by the user device 12 and store the query files 96, 98 in the SS memory 78. The SS memory 78 may store a SID/query table 124 relating the SIDS to query requests.

The analytics server 18 includes the operating (or analytics) system 44, which analyzes analytics data and generates search metrics 128 for updating the CTR-based search model 116. The analytics data includes the user analytics data 100, the SS analytics data 122, and/or partner analytics data 129. The analytics server 18 can receive analytics data from different sources in a variety of different formats. As an example, the analytics server 18 may receive analytics data including an SID directly from the user device 12. As another example, the analytics server 18 may receive analytics data from the user device 12 without a SID. The partner analytics data 129 is generated by the partner server 20. The partner analytics data 129 may include any analytics data disclosed herein as being tracked, generated and/or stored by one or more of the servers 16, 18. The partner analytics data may include groups of user analytics data and may also include partner specific information, such as a partner ID. The partner server (PS) control module 58 may generate and/or track analytics data similarly to the control modules 54, 56. The partner analytics data 129 may include analytics data specific to the partner server 20 and/or specific to the users and/or user devices associated with the partner server 20.

The search metrics 128 may be indicative of an amount of user engagement with the search results. The search metrics 128 may include: non-normalized (or traditional) CTRs; normalized CTRs as disclosed herein; gaps between non-normalized CTRs and normalized CTRs; an amount of time between when search results are provided and a first click is received for a search result item associated with the search results; an amount of time between clicks on search result items; a number of search results for which no clicks are received; a length of a search session; and/or other search metrics.

The analytics server (AS) control module 56 may include an analytics acquisition module 130, a normalized CTR module 132, a synthetic search ID (SSID) assignment module 134, and an analysis module 136. The analytics acquisition module 130 collects the user analytics data 100, the SS analytics data 122, and/or the partner analytics data 129 (collectively analytics data 138) from the user device 12 and the servers 16, 20. The normalized CTR module 132 determines the normalized CTRs and may determine the non-normalized CTRs. The normalized CTRs and non-normalized CTRs may be generated based on certain CTR parameters. The CTR parameters include: a total number of queries TQ; a number of queries having search results that received at least one click S1C; and a total number of clicks for the total number of queries provided TC. Each of the CTR parameters may be associated with one or more users and/or one or more user devices. The CTR parameters may be included in the analytics data 100, 122, 129 and/or 138. The normalized CTR module 132 may determine NCTR by dividing the total number of searches with at least 1 click S1C by the total number of queries TQ, as shown by equation 2.

$$NCTR = \frac{S 1 C}{TQ} \qquad ( 2 )$$

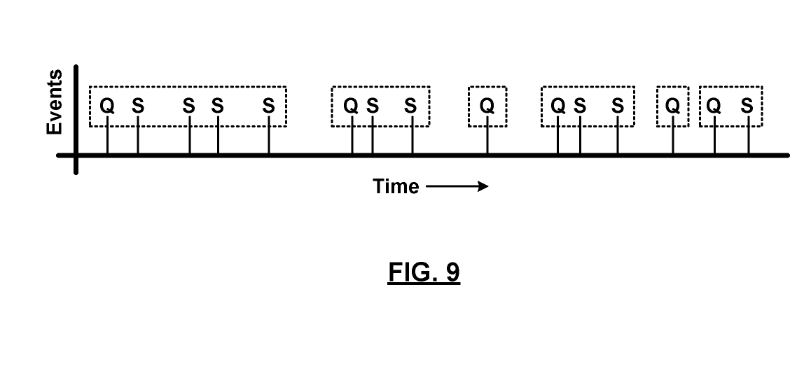

S1C may be a number of queries having search result items that received at least one valid selection (or valid click). A valid selection is defined below with respect to the method of FIG. 9. The NCTR may be indicative of how well the CTR-based scoring model 116 performed across a group of searches. The NCTR may be determined based on SIDs or SSIDs, where the SIDs and the SSIDs correlate queries with selection events.

As an example, a user device may submit 10 query requests and each corresponding search may provide 10 search results. If the user device selects all 10 search results from the first query, but then does not select any results from the next 9 queries, the TCTR is 100% although there is no engagement with search results from 9 of the 10 searches. However, using the same example, the NCTR is 10%, which is more indicative of overall user engagement with the search results of the 10 queries. Accordingly, in some cases, the NCTR search metric is a better search metric than the TCTR search metric for indicating overall user engagement with search results.

The normalized CTR module 132 and/or the AS control module 56 may determine gaps between TCTRs and NCTRs by subtracting the NCTRs from the TCTRs or vice versa. The gaps may indicate an amount of skew in the performance of the CTR-based scoring model 116. For example, a large gap (e.g., 90%) may indicate that the CTR-based scoring model 116 performs inconsistently across a group of queries. As described herein, the normalized CTR module 132 and/or the AS control module 56 may update the CTR-based scoring model 116 in response to the gaps determined. For example, the normalized CTR module 132 and/or the AS control module 56 may update the CTR-based scoring model 116 if a gap value is greater than a predetermined threshold.

The SSID assignment module 134 assigns SSIDs to query files and selection files when SIDs have not been generated and/or when the query files and the selection files do not include SIDs. The assignment of the SSIDs is timestamp based and is further described below. The analysis module 136 analyzes the analytic data 138 to generate the search metrics 128.

The AS memory 80 may store the search metrics 128, the analytics data 138, query files 140, an SSID/query table 142, and the selection files 98. The query files 140 may include the query files 96 and/or 120. The analytics server 18 may receive the query files 96, 120 and/or the selection files 98 from the user device 12 and the search server 16 and store the files 96, 98, 120 in the AS memory 80. This may include, as is further described below, adding a synthetic search ID (SSID) to the files 96, 98, 120. The SSID/query table 142 relates the SSIDs to query requests.

The partner server 20 includes the operating (or partner) system 46, which performs certain search operations including transferring data between (i) the user device 12 and (ii) the servers 16, 18. The partner server (PS) control module 58 may include a PS transfer module 150 and a PS analytics module 152. The PS transfer module 150 may control transfer of files and data between the user device 12 and the servers 16, 18. The PS analytics module 152 may generate the partner analytics data 129. The PS memory 82 may store the query files 96, selection files 98, user analytics data 100, partner analytics data 120 and/or a SID/query table 154. The SID/query table 154 may relate SIDs to query requests. The SIDs may be assigned by the PS control module 58, for example, when the partner server 20 receives query requests from the user device 12. The SID/query table 154 may be shared with the servers 16, 18. The SIDs may then be included in the query files 96 and/or the selection files 98. In this example, the PS control module 58 assigns the SIDs instead of the search module 110.

The servers 16, 18 may directly communicate with the user devices 12 via the network 14 or may indirectly communicate with the user devices 12 via the partner server 20. The partner server 20 may be associated with a third party and leverage search functionality performed by one or more of the search servers 16, 18. The third party may be a company or organization other than that which operates one or more of the servers 16, 18. Examples of the third party are an Internet search provider and a wireless communications service provider. During operation, the user devices 12 may send search queries to the search server 16 and receive search results via the partner server 20. The partner server 20 may provide a user interface to the user devices 12 and/or modify a search experience provided on the user devices 12. The partner server 20 may store and analyze analytics data indicating how users interact with search results. The search results may be provided from the partner server 20 to the user devices 12.

The memories 76, 78, 80, 82 may each include volatile and/or non-volatile memory. The memories 76, 78, 80, 82 may include random access memory (RAM), read-only memory (ROM), non-volatile RAM (NVRAM), electrically-erasable programmable ROM (EEPROM), Flash memory, hard disk drives (HDD), magnetic tape drives, optical storage drives and/or media (e.g., compact discs, digital versatile discs, and/or optical discs). The memories 76, 78, 80, 82 may also include software programs with instructions that are executed by the control modules 52, 54, 56, 58.

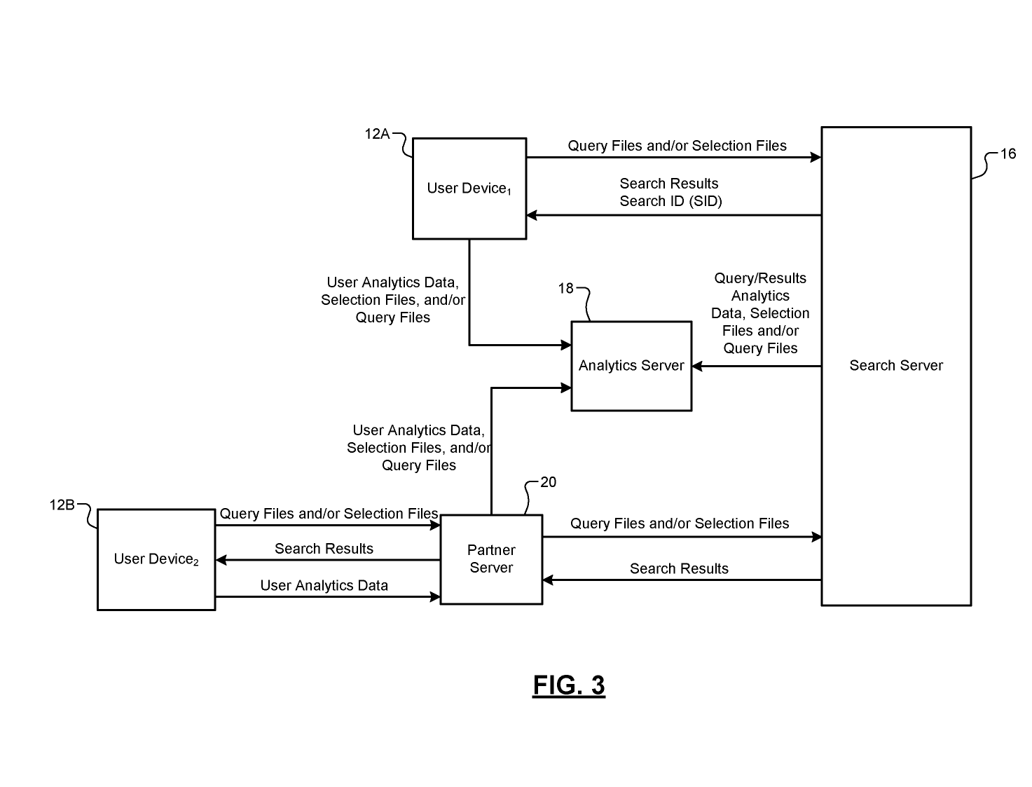

FIG. 3 shows certain operating aspects of the search system 10 of FIG. 1 including query file, selection file, and analytics data generation and transfer. FIG. 3 shows two user devices 12A and 12B and the servers 16, 18, 20. During operation, the user devices 12A, 12B generate query requests and provide the query requests in query files to the servers 16, 20, as shown. The query files may include the query related information described above and other data, such as: geographical location of the corresponding user device; an Internet protocol (IP) address of the user device; platform data for an operating system version of the user device, a device type, or a web-browser version; and partner-specific data. The partner server 20 transfers the query files generated by the user device 12B to the search server 16.

The search server 16 receives the query requests, conducts searches and generates search results. In one embodiment, the search server 16 assigns SIDS to the queries and provides the SIDS along with the search results. The SIDS are unique IDs that identify the specific queries. The search results are transmitted to the user devices 12A, 12B. The user devices 12A, 12B may display the search results to the user as a set of user selectable links (e.g., web/app links). The user may interact with the user selectable links (e.g., touch or click the links) in order to launch web/app states associated with the user selectable links. The user device 12 collects user analytics data indicating a variety of different user interactions with the search results. The user analytics data, in addition to the user analytics data disclosed above, may include data related to user selections of the user selectable links (referred to herein as “selection events”), such as timestamps indicating the time at which the user selects the user selectable links (i.e., the time of a selection event). As an example, a selection event may include a user touching (e.g., tapping) a user selectable link on a touch-screen device. Another example selection event may include a user selecting a link with a mouse.

The user devices 12A, 12B may receive SIDS included in the search results and assign the SIDS to various user activities. For example, the user devices 12A, 12B may assign the received SIDS to each selection event associated with a received search query. The user devices 12A, 12B may also timestamp the selection events. In cases where the user devices 12A, 12B does not use or receive SIDS, the user devices 12A, 12B may timestamp the different selection events without assigning SIDS. As described herein, if the analytics server 18 does not have a SID for a query, the analytics server 18 may generate an SSID to assign to the corresponding user selection events.

The user devices 12A, 12B and the servers 16, 20 provide analytics data, as described above, to the analytics server 18 for analysis, search metric generation and CTR-based scoring model updating. The analytics data may be based on the queries, the search results and corresponding search related information. If the user devices 12A, 12B receive SIDS, the user devices 12A, 12B may include the SIDS with the user analytics data provided to the analytics server 18. This allows the analytics server 18 to correlate query analytics data and result analytics data with the user analytics data based on the SIDS.

In one embodiment, the user devices 12A, 12B do not receive SIDS along with the search results. For example, the search server 16 may not transmit SIDS to the user devices 12A, 12B. As another example, if the search server 16 transmits an SID to the partner server 20, the partner server 20 may not transmit the SID to the user device 12B. In this example, the partner server 20 may implement a partner analytics technique that tracks user interactions with search results differently than the tracking technique performed by one or more of the servers 16, 18. If an SID is not transmitted along with analytics data back to the analytics server 18, the analytics server 18 may correlate the analytics data based on SSIDs generated by the analytics server 18.

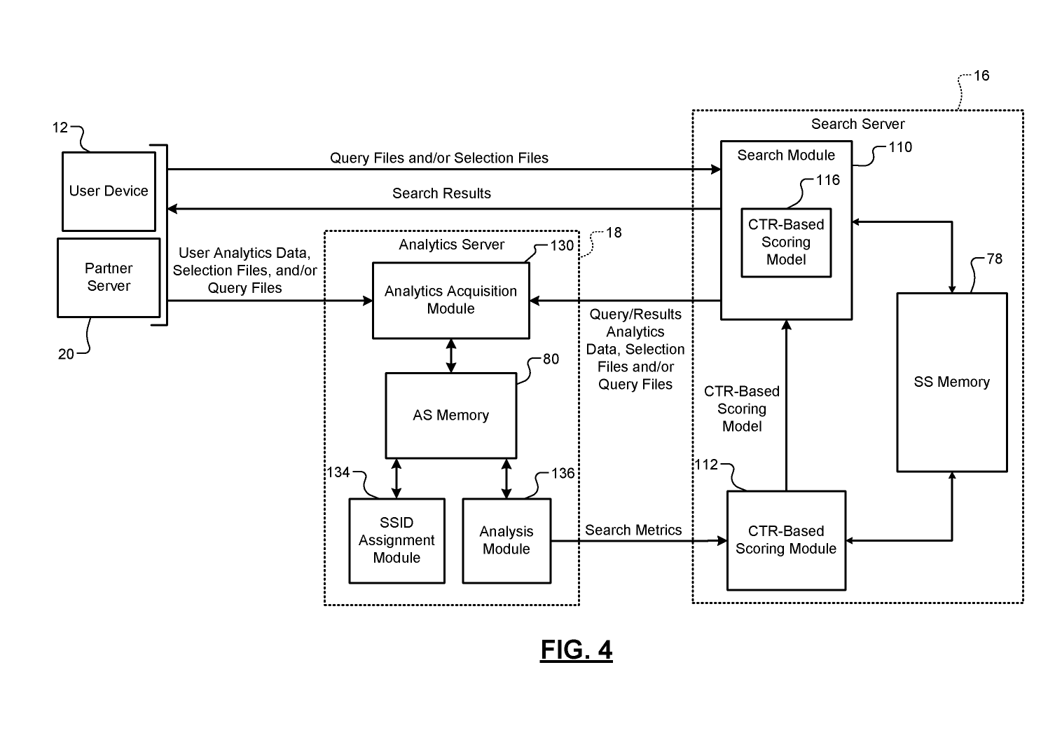

FIG. 4 shows certain operating aspects of the search system 10 of FIG. 1 including SSID assigning, search metric generating, and CTR-based scoring model updating. FIG. 4 shows a user device 12 and servers 16, 18, 20. During operation, the user device 12 generates a query request, which may be included in a query file and provided to the search module 110. The search module 110 generates search results based on the CTR-based scoring model 116 and a database of possible search documents, links, APPs and other search result items stored in the SS memory 78. The CTR-Based scoring model 116 is updated by the CTR-based scoring module 112 based on search metrics provided by the analysis module 136 of the analytics server 18.

The CTR-based scoring module 112 may generate result scores for each of the search results. The user device 12 may display the search results based on the result scores. The SS memory 78 may include searchable documents (e.g., search documents associated with app/web states, images, applications for download, videos, or other searchable verticals). A search vertical describes a specific type of content on which a query is run and for which results are presented. For example, an APP store may have content related to people, sports, human activity, jobs, companies, groups, universities, etc. Subsequently, the APP store may have corresponding search verticals (e.g., sports, human activity, jobs, companies, groups, universities, etc.) for searching each type of content. Thus, a search query running on a sports search vertical will return a list of APPs on sports related APPs that match the search query. Verticals may be implemented by filtering out content that does not match the search verticals utilized (e.g., for a sports search vertical, searching content and filtering out results that are not sports related) or may be implemented by only searching content corresponding to the particular vertical. The search module 110 may identify and score search result items based on how well the search result items match the query request. Additionally, or alternatively, the CTR-based scoring model 116 may include one or more machine learning models or other scoring algorithms for identifying and scoring the search result items.

The analysis module 136 generates the search metrics based on analytics data and parameters stored in the AS memory 80. The analytics data and parameters are collected, tracked and/or updated by the analytics acquisition module 130, which receives analytics data from the user device 12 and the servers 16, 20.

The SSID assignment module 134 may assign SSIDs to queries and tag query files and selection files with the SSIDs based on timestamps of the query files and selection files. The SSID assignment module 134 identifies search queries and/or selection events in the AS memory 80 that are not assigned SIDs. The SSID assignment module 134 can then assign SSIDs to the identified search queries and/or corresponding selection events. The SSID is synthetic in that the identification is assigned by the SSID assignment module 134 instead of the search module 110. The analysis module 136, when determining CTRs, groups the query files and the selection files based on the SSIDs or SIDs in the query files and selection files. A non-normalized CTR and a normalized CTR may be determined for each group including a query file and one or more selection files.

The SS memory 78 may store any number of CTR-based scoring models and non-CTR-based scoring models, which may be accessed by the search module 110 and used when conducting searches. In one embodiment, scoring models are copied and the copied versions are updated, such that old versions of the scoring models remain in the SS memory 78 and may be used by the search module 110. This allows the search module 110 and/or the analysis module 136 to determine searching trends by comparing the scoring modules. The search module 110 may exchange a current scoring model with one of the previously used scoring models in response to identifying search metrics that indicate the current scoring model is deficient in some manner and/or less effective than a previously used scoring model.

The analytics acquisition module 130 may request (e.g., on a scheduled basis) the analytics data from the user device 12 and the servers 16, 20. The user device 12 and/or the servers 16, 20 may initiate the transfer of analytics data to the analytics acquisition module 130 (e.g., on a scheduled basis). The analytics acquisition module 130 stores the analytics data in the AS memory 80. The analytics data may be formatted in a variety of formats, which may be selected by an operator of the analytics server 18. The analytics data may be retrieved by the SSID assignment module 134 and/or the analysis module 136 based on user ID, time stamp, event type (e.g., query event or selection event), and/or other parameters disclosed herein.

The analytics acquisition module 130 may receive partner analytics data that includes user analytics data from multiple user devices over a period of time (i.e., a bulk transfer of data related to multiple user devices that performed multiple searches). Such analytics data transfers may occur on a scheduled basis and/or based on a volume of data collected. In one embodiment, the analytics data transferred by the partner server 20 to the analytics acquisition module 130 on a single query event or a single user device basis. This may occur when the partner server 20 monitors and transfers the user analytics data as query files and selection files are generated (referred to as occurring “in real time”).

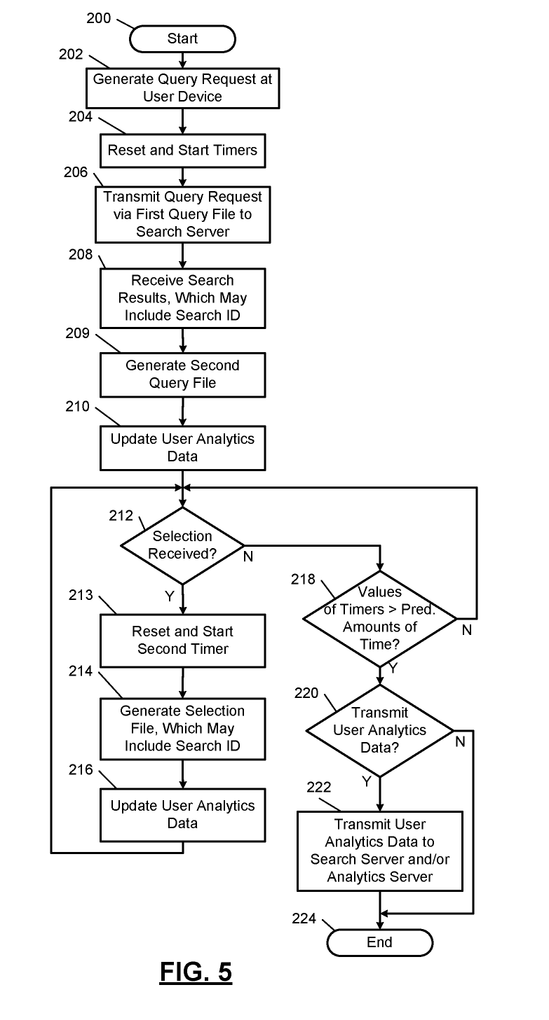

For further defined structure of the modules of FIGS. 1-2 and 4, see methods of FIGS. 5-8 described below and the definition for the term “module” provided below. The systems disclosed herein may be operated using numerous methods, examples of which are illustrated in FIGS. 5-8. The methods of FIGS. 5-8 are directed to operation respectively of the user device 12, the search server 16, the analytic server 18 and the partner server 20 of FIG. 2. Although the following methods are shown as separate methods, one or more methods and/or operations from separate methods may be combined and performed as a single method. Also, each of the methods may be performed while any of the other methods are performed.

In FIG. 5, a method of operating a user device is shown. Although the following operations are primarily described with respect to the implementations of FIGS. 1-4, the operations may be easily modified to apply to other implementations of the present disclosure. The operations may be iteratively performed. The method may begin at 200. Although user analytics data is shown as being updated during operations 210 and 216, the user analytics data may be updated throughout the method of FIG. 5. At 202, the application search module 90 receives an input from a user and generates a query request. A query request signal is generated, which may include: a user ID; a user device ID; a timestamp of when the query request is generated; keywords and/or other user input and/or selected search identifiers; and/or other query related information. The application search module 90 may timestamp the query request. At 204, the application search module 90 may reset and start one of timers 95 in response to receiving the user input to generate the query request. In one embodiment, the one of the timers 95 is started after operation 208 and when the search results have been received rather than when the query request is generated. A first timer may be used to indicate an amount of time since the query request was generated or transmitted. A second timer may be used to indicate (i) an amount of time between generation or transmission of the query request and a first selection/click, or (ii) an amount of time between selections/clicks.

At 206, the application search module 90 may generate, store and transmit a query file including the query request. The query file is stored in the memory 76 and is transmitted to one or more of the servers 16, 18, 20 via the UD MAC module 60 and the UD PHY module 68. The query file may be transmitted directly to the search server 16 or indirectly via the partner server 20. The application search module 90 or other module (e.g., the UD MAC module 60 or the UD PHY module 68) of the user device 12 may timestamp the query file to indicate a time when the query file is transmitted to the one or more of the servers 16, 18, 20.

At 208, the application search module 90, based on the query request and/or the query file, receives via the UD PHY module 68 and the UD MAC module 60 a search results file from one of the servers 16, 18, 20. The search results file includes search results, which may be initially transmitted from the search module 110. The search results may include a SID. The search results and the SID may be stored in the memory 76. At this point, the user may interact with the search results (e.g., selects links in the search results). At 209, the SDK module 94 may generate a second query file including the query file information included in the first query file and, if provided, the SID.

At 210, the UD analytics module 92 may update the user analytics data 100 based on the information in the query request, the query files, the search results, and/or the user interactions with the search results. The user device 12 may generate and/or update the user analytics data 100 and assign the SID to the user analytics data 100, such that the user analytics data 100 is correlated with query analytics data and/or result analytics data at the analytics server 18.

At 212, the application search module 90 and/or SDK module 94 may monitors user engagement with the search results, such as clicks on SERP impressions. When the user clicks on a search result item, task 214 is performed; otherwise, task 218 is performed.

At 213, a second one of the timers 95 may be reset and/or started to determine an amount of time between a latest selection event (or click) and a selection event (or click) prior to the latest selection event (or click). At 214, the SDK module 94 generates a selection file when the user clicks on a search result item. The selection file may include the user ID, the user device ID, a timestamp of when the click occurred, a search result item ID, the SID, and/or other selection related information. The selection file is stored in the memory 76. At 216, the UD analytics module 92 may update the user analytics data 100 based on the information in the selection file.

At 218, the application search module may determine if values of the timers 95 are greater than respective predetermined amounts of time. The times of the timers 95 may be indicative of user engagement with search results. If one or more of the values are greater than the respective predetermined amounts of time, then task 220 may be performed; otherwise, task 212 may be performed.

At 220, the UD analytics module 92 determines whether to transmit the user analytics data 100 to one or more of the servers 16, 18, 20. The user device 12 may transmit the user analytics data 100 directly to the analytics server 18 or indirectly via the partner server 20. If the user analytics data 100 is to be transmitted, task 222 is performed; otherwise, the method may end at 224. At 222, the UD analytics module 92 transmits the user analytics data 100 to the one or more of the servers 16, 18, 20. The method may end at 224.

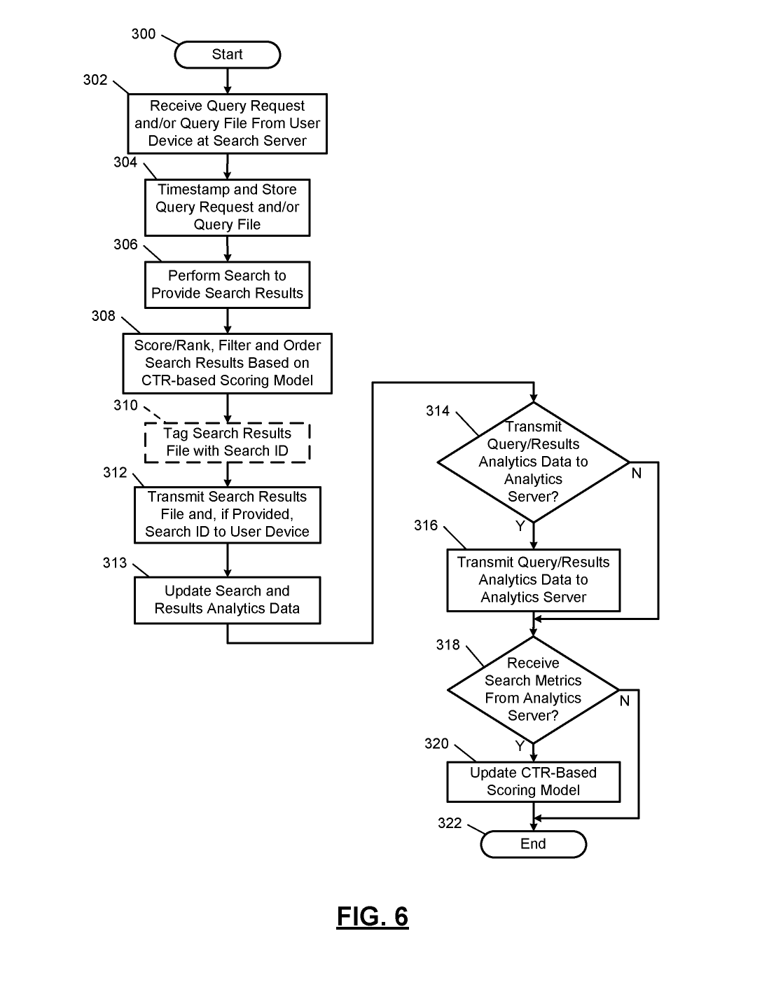

In FIG. 6, a method of operating a search server is shown. Although the following operations are primarily described with respect to the implementations of FIGS. 1-4, the operations may be easily modified to apply to other implementations of the present disclosure. The operations may be iteratively performed. The method may begin at 300. At 302, the search module 110 receives via the SS PHY module 70 and the SS MAC module 62 a query request and/or query file from the user device 12.

At 304, the search module 110 or other module of the search server 16 may timestamp the query request and/or the query file indicating when the query request and/or query file was received. At 306, the search module 110, based on information in the query request and/or the query file, performs a search to provide search results.

At 308, the CTR-based scoring module 112 may score/rank the search results based on the CTR-based scoring model 116. The search results may then be filtered and placed in an order based on the score/ranking of the search results to generate a resultant search result file. At 310, the SS control module 54 and/or one of the modules 110, 112 may tag the search results file with a SID.

At 312, the SS control module 54 transmits, via the SS MAC module 62 and the SS PHY module 70, the search results file to the user device 12. This may include transmission of the SID. The search result file including the SID may be transmitted in the form of a hypertext transfer protocol (HTTP) response signal to the user device 12. At 313, the SS analytics module 114 may update the SS analytics data 122 based on the information received in the query request and/or query file and/or information contained in the search results file.

At 314, the SS analytics module 114 determines whether to transmit the SS analytics data 122 to the analytics server 18. If the SS analytics data is to be transmitted, task 316 is performed; otherwise, task 318 is performed. At 316, the SS analytics module 114 transmits, via the SS MAC module 62 and the SS PHY module 70, the SS analytics data to the analytics server 18.

At 318, the CTR-based scoring module 112 determines whether search metrics have been received from the analytics server 18. If search metrics have been received, task 320 is performed; otherwise, the method may end at 322.

At 320, the CTR-based scoring model 116 is updated based on the search metrics received. This may include updating the CTR-based scoring model 116 based on one or more TCTRs and NCTRs as well as other search metrics. As an example, the CTR-based scoring module 112 may weight each of the search metrics (e.g., multiple each of the search metrics by predetermined weights) and sum the resultant values to provide updated scores and/or scoring parameters to be included in the CTR-based scoring model 116. The CTR-based scoring module 112 may update the CTR-based scoring model 116 in response to a variety of different conditions that may be set by a system operator. The system operator may have the CTR-based scoring model 116 updated over time. In some cases, the system operator and/or the CTR-based scoring module 112 may update the CTR-based scoring model 116 if new search content has been acquired. For example, the system operator may update the scoring model if new content is acquired for a specific vertical (e.g., a search category, such as hotels, restaurants, APPs, images, videos, etc.). In this case, the new scoring model may be generated based on the newly acquired content.

The CTR-based scoring module 112 may be configured to notify the system operator in response to changes in a TCTR, an NCTR, and/or a CTR gap. The CTR gap is indicative of whether the CTR-based scoring model provides uniform performance across different search queries. The CTR-based scoring module 112 may be configured to automatically modify the CTR-based scoring model 116 in response to changes in the TCTR, NCTR, and/or CTR gap. For example, the CTR-based scoring module 112 may modify the CTR-based scoring model 116 in response to drops in the NCTR and/or an increase in the CTR gap.

After implementing a new scoring model, the CTR-based scoring module 112 may monitor search metrics. The CTR-based scoring module 112 may perform different operations in response to the search metrics. For example, the CTR-based scoring module 112 may notify the system operator of search system anomalies (e.g., changes in the search metrics). As another example, the CTR-based scoring module 112 may automatically update the CTR-based scoring model 116 (e.g., return the CTR-based scoring model 116 to a previous scoring model) in response to changes in the search metrics (e.g., changes in TCTR, NCTR, and CTR gap) caused by a change in the CTR-based scoring model 116. As another example, the CTR-based scoring module 112 may automatically update the CTR-based scoring model 116 (e.g., return the CTR-based scoring model 116 to a previous scoring model) in response to changes in one or more magnitudes of the search metrics, such as magnitudes of TCTR, NCTR, and CTR gap. This may occur if a previous CTR-based scoring model resulted in better search metrics.

In another embodiment, the CTR-based scoring module 112 may use a first CTR-based scoring model for a first period of time. The analysis module 136 may determine search metrics for the first CTR-based scoring model for the first period of time. After the first period of time, the first CTR-based scoring model may be updated to a second CTR-based scoring model. The CTR-based scoring module 112 may then monitor the search metrics associated with the second CTR-based scoring model over a second period of time. The CTR-based scoring module 112 may switch from the second CTR-based scoring model back to the first CTR-based scoring model if the search metrics meet certain conditions, which may be defined by the system operator.

As an example, the first CTR-based scoring model may have a 10% CTR gap. If the CTR gap widens (e.g., to greater than a predetermined threshold) after transitioning to the second CTR-based scoring model, the CTR-based scoring update module 112 may replace the second CTR-based scoring model with the first CTR-based scoring model or a third CTR-based scoring model. Updating the CTR-based scoring model in this manner may assure that the search system 10 performs uniformly well for different queries. The system operator may be notified when the CTR gap exceeds the predetermined threshold and/or when the current CTR-based scoring model is returned to the first CTR-based scoring model or changed to a third CTR-based scoring model. The notification to the system operator may suggest to the system operator that analysis of the current CTR-based scoring model is advised. The notification may also indicate by how much the CTR gap has widened due to increases and/or decreases in a TCTR and/or an NCTR.

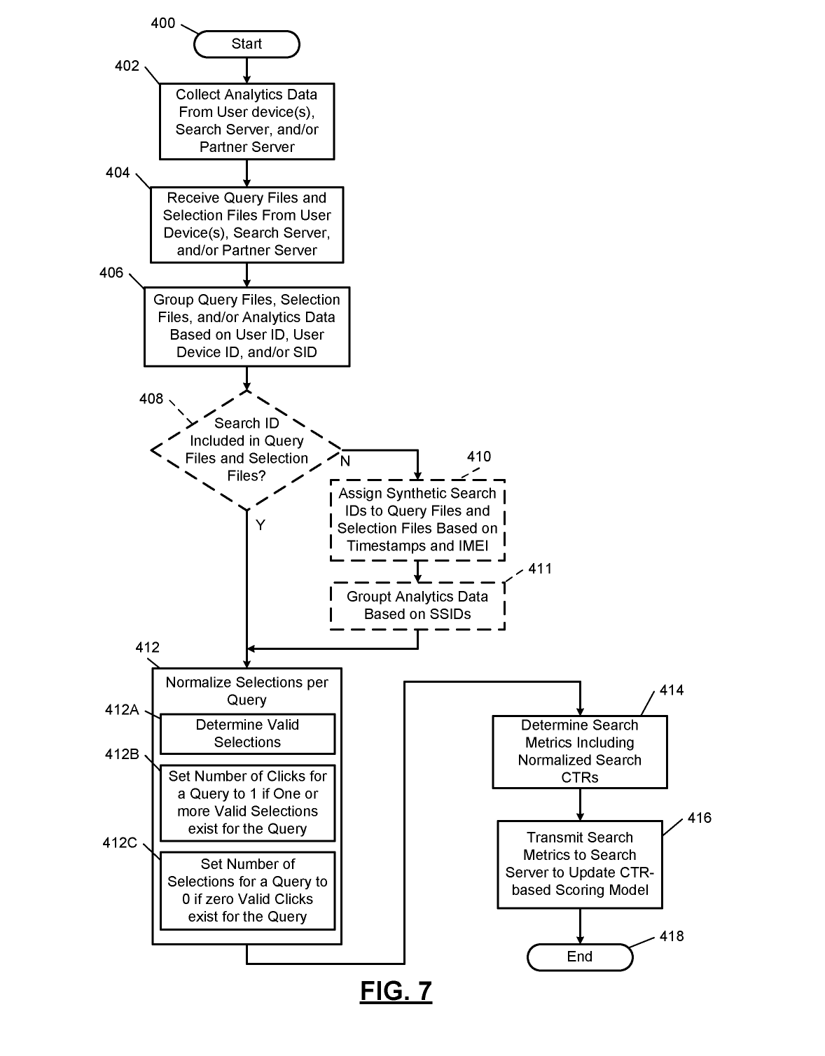

In FIG. 7, a method of operating an analytics server is shown. Although the following operations are primarily described with respect to the implementations of FIGS. 1-4, the operations may be easily modified to apply to other implementations of the present disclosure. The operations may be iteratively performed. The method may begin at 400. At 402, the analytics acquisition module 130 collects analytics data from the user device 12 and/or other user devices and from one or more of the servers 16, 18, 20. At 404, the analytics acquisition module 130 may also collect query files and selection files from the user device 12 and/or other user devices and from one or more of the servers 16, 18, 20. The collecting of the query files and selection files includes loading query event information and selection event information into the AS memory 80. The query event information and the selection event information may be combined into a table based on groups, as further described with respect to the following operations.

At 406, the AS control module 56 and/or the SSID assignment module 134 may group the query files, the selection files and/or the analytics data based on user ID, user device ID (e.g., IMEIs), and/or SID.

At 408, the AS control module 56 and/or the SSID assignment module 134 may determine whether a SID is included in the query files and the selection files. If an SID is not included, task 410 is performed; otherwise, task 412 is performed.

At 410, the SSID assignment module 134 assigns an SSID to each group of query files and selection files. The SSIDs are assigned to allow the normalized CTR module 132 to find all clicks (or selection events) corresponding to each query event. The grouping may be performed based on user ID, user device ID, and/or query. This may include tagging each of the query files and selection files with a unique SSID. The tagging is performed based on timestamps of the query files and selection files. Table 1 below is provided as an example to illustrate assignment of SSIDs to groups based on user device IMEIs and queries. Table 1 includes group numbers, the user device IMEIs, timestamps for queries/searches and clicks, and the SSIDs.

TABLE 1
SSID Assignment Example

| | IMEI | Timestamp | Event | SSID |
|---|---|---|---|---|
| Group I | IMEI1 | 2015-01-01 00:00:00 | Query/Search | S1 |
| | IMEI1 | 2015-01-01 00:02:00 | Click | S1 |
| | IMEI1 | 2015-01-01 00:04:00 | Click | S1 |
| Group II | IMEI1 | 2015-01-01 01:00:00 | Query/Search | S2 |
| | IMEI1 | 2015-01-01 01:03:00 | Click | S2 |
| Group III | IMEI1 | 2015-01-01 04:00:00 | Query/Search | S3 |
| Group IV | IMEI2 | 2015-01-01 00:01:00 | Query/Search | S4 |
| | IMEI2 | 2015-01-01 00:05:00 | Click | S4 |

For each group, the selection events that occur after a query, the SSID assignment module 134 assigns the selection events the same SSID as the query, such that clicks that occur subsequent to a first query and before a second query belong to the first query. If a selection event occurs too late (e.g., a predetermined period) after a query, then the SSID assignment module 134 may regard the selection event as not being associated with any query. A late selection event may indicate that a query was dropped from the analytics data, or another issue affecting the integrity of the analytics data occurred.

FIG. 9 provides an example illustration of query events and selection events sorted by timestamp for a single user. FIG. 9 illustrates an example set of certain analytics data including 6 query events (Q) and 9 selection events (S). The dotted boxes indicate which queries and selection events are assigned the same SSIDs. For the example shown, the SSID assignment module 134 may assign 6 different SSIDs; one for each group of query/selection events included in the dotted boxes. In FIG. 9, two query events do not result in subsequent selection events.

At 411, the SSID assignment module 134 may group the analytics data including the queries and selection events based on SSIDs. At 412, the normalized CTR module 132 normalizes the selection in each of the groups to 0 or 1 selection per query. A clicks-per-query value for queries and/or groups having one or more clicks per query is set to 1. For example, the number of clicks for Group I in Table 1 is 2. Normalization performed at 412 reduces this number to 1. A click per query value for queries and/or groups having no clicks is set to 0.

At 412A, the normalized CTR module 132 may determine which of the selection files are valid. This may include determining which of the selection files have timestamps that are not greater than: a first predetermined amount of time after a timestamp of a corresponding query file; and/or a second predetermined amount of time after a timestamp of a previous selection file in the same group. If (i) a timestamp of a selection file of a group is greater than the first predetermined amount of time after the timestamp of the corresponding query file, and/or (ii) an amount of time between timestamps of two selection files of the group is greater than the second predetermined amount of time, then the click associated with the selection file of concern may not have been associated with the query of the group. This removes selection files associated with clicks (“late clicks”) that occur too long after a previous click and/or query. Although the late clicks may have occurred subsequent to a query, the late clicks may not have been directed to search results of the query. Selection files associated with late clicks are invalid and are not used when performing the following operations 412B and 412C.

At 412B, the number of clicks for a query is reduced to 1 for a query having one or more valid selection files. At 412C, the number of clicks for a query is set to 0for a query that has 0 valid selection files.

At 414, the analysis module 136 determines search metrics including normalized search CTRs based on the normalized clicks per query values determined at 412 and the analytics data received. TCTRs and NCTRs may be determined using equations 1 and 2. For the set of analytics data illustrated in FIG. 9, the analysis module 136 may determine a TCTR value of 9/6, an NCTR value of 4/6, and a CTR gap value of 5/6.

At 416, the analysis module 136 may, via the AS MAC module 64 and the AS PHY module 72, transmit the search metrics to the search server 16 to have the CTR-based scoring model 116 updated. The method may end at 418.

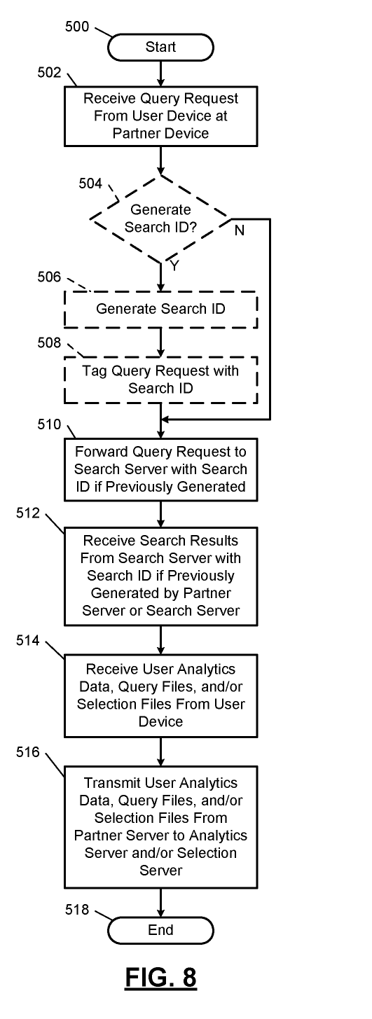

In FIG. 8, a method of operating a partner server is shown. Although the following operations are primarily described with respect to the implementations of FIGS. 1-4, the operations may be easily modified to apply to other implementations of the present disclosure. The operations may be iteratively performed. The method may begin at 500. At 502, the PS transfer module 150 receives a query request and/or query file from the user device 12 via the PS MAC module 66 and the PS PHY module 74.

At 504, the PS transfer module 150 may determine whether to generate a SID for the received query request and/or query file. If a SID is to be generated, task 506 is performed; otherwise, task 510 is performed. At 506, the PS transfer module 150 generates the SID. At 508, the PS transfer module 150 tags the query request and/or query file with the SID.

At 510, the PS transfer module 150 transfers the query request and/or query file to one or more of the servers 18, 20. This may include transmitting the SID. At 511, the PS analytics module 152 may update the partner analytics data 129 based on the reception and transmission of the query request and/or query file at 502 and 510 and/or based on the content of the query request and/or query file.

At 512, the PS transfer module 150 may receive search results from the search server 16 associated with the query request. The Search results may include the SID assigned by the PS transfer module 150 or a SID assigned by the search module 110. At 513, the PS transfer module 150 forwards the search results and, if provided, one of the SIDs to the user device 12.

At 514, the PS analytics module 152 may receive: the user analytics data 100 from the user device 12; the SS analytics data 122 from the search server 16; and/or the query files 96, 120 and/or the selection files 98 from the user device 12 and/or search server 16. The partner server 20 may collect user analytics data for a period of time and then transmit the user analytics data to the analytics server 18. At 516, the PS transfer module 150 transmits the analytics data 100, 122, query files 96, 120 and/or selections files 98 received during operation 514 to the analytics acquisition module 130. The method may end at 518.

The above-described operations of FIGS. 5-8 are meant to be illustrative examples; the operations may be performed sequentially, synchronously, simultaneously, continuously, during overlapping time periods or in a different order depending upon the application. Also, any of the operations may not be performed or skipped depending on the implementation and/or sequence of events.

The above-described methods include generation of normalized CTRs for improved user search result engagement evaluation. The normalized CTRs are used to update scoring models, which improves provided search results, which in turn improves user engagement with search results. The methods allow an analytics server and/or analysis module to determine a normalized CTR based on a received dataset, which includes a time series of clicks and query events and does not include SIDS.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A system comprising:
a search module configured to (i) receive a plurality of query requests from one or more user devices for respective queries, and (ii) based on the plurality of query requests and a click-through-rate (CTR)-based scoring model, conduct a plurality of searches to provide search results for each of the queries;
an analytics acquisition module configured to acquire analytics data corresponding to the queries, wherein the analytics data includes (i) query files for the respective queries, and (ii) one or more selection files for each of the queries for which a selection event occurred, and wherein at least some of the selection events occur when a user of the one or more user devices selects a search result item in the search results provided for the queries;
a CTR module configured to determine a normalized CTR based on the analytics data; and
a scoring module configured to update the CTR-based scoring model based on the normalized CTR,
wherein the search module is configured to, subsequent to the plurality of searches, conduct a search based on the updated CTR-based scoring model.

2. The system of claim 1, wherein:
the search module is configured to (i) assign search identifiers to the queries and corresponding search results, and (ii) transmit the search results of the queries and the search identifiers to the one or more user devices; and
the CTR module is configured to (i) based on the search identifiers, group the selection files corresponding to the queries, and (ii) determine the normalized CTR based on, for each of the queries, a number of user selections of search result items provided in the corresponding search results.

3. The system of claim 1, further comprising an assignment module configured to assign synthetic search identifiers to the query files and the selection files of the queries based on timestamps of the query files and the selection files,
wherein the CTR module is configured to (i) based on the synthetic search identifiers, group the selection files corresponding to the queries, and (ii) determine the normalized CTR based on, for each of the queries, a number of user selections of search result items provided in the corresponding search results.

4. The system of claim 3, wherein:
the selection events occur when a user of the one or more user devices provides a user input or click subsequent to one of the queries and prior to a next query after the one of the queries; and
the assignment module is configured to
determine whether the selection events are valid selection events, wherein an evaluated selection event is determined to be a valid selection event if the evaluated selection event has not occurred more than a predetermined amount of time after a timestamp of (i) a corresponding one of the query requests, (ii) a corresponding one of the query files, or (iii) another selection event, and
assign the synthetic search identifiers to the valid selection events and not to invalid selection events.

5. The system of claim 1, wherein the CTR module is configured to normalize a number of selections of search result items per query to 0 or 1.

6. The system of claim 1, wherein:
the CTR module is configured to determine a non-normalized CTR; and
the scoring module is configured to update the CTR-based scoring model based on the non-normalized CTR.

7. The system of claim 1, further comprising at least one server comprising the search module, the analytics module, the CTR module and the scoring module.

8. The system of claim 1, further comprising:
a search server comprising the search module and the scoring module; and
an analytics server comprising the analytics acquisition module and the CTR module.

9. The system of claim 1, wherein the CTR module is configured to determine the normalized CTR based on (i) a number of normalized selections of search result items provided in the search results of the queries, and (ii) a total number of queries.

10. A user device comprising:
an input device configured to receive a first query request from a user;
an application search module configured to (i) generate a first query file including the first query request, (ii) transmit the first query file to a search server, and (ii) based on the first query file, receive from the search server a response signal including search results;
a development module configured to, based on a state of a timer, generate selection files in response to user inputs provided subsequent to the application search module receiving the search results and prior to a second query request, wherein each of the selection files includes (i) a timestamp of one of the user inputs or clicks, or (ii) a search identifier provided in the response signal, and wherein the development module refrains from generating a selection file when a predetermined time of the timer has lapsed; and
an analytics module configured to update analytics data of the user device based on information in the first query file and the selection files, and transmit the analytics data to an analytics server to update a normalized click-through-rate-based scoring model.

11. The user device of claim 10, wherein:
the development module is configured to generate a second query file including at least one of (i) the search identifier, or (ii) a timestamp of the query request or the first query file; and
the analytics module is configured to update the analytics data based on information in the second query file.

12. The user device of claim 10, wherein each of the selection files includes a timestamp of when one of the user inputs is received at the user device.

13. The user device of claim 10, wherein each of the selection files includes the search identifier provided in the response signal.

14. The user device of claim 10, wherein:
the development module is configured to, based on the state of the timer, generate the selection files in response to respective selections by the user of search result items provided in the search results; and
each of the selection files includes a timestamp of one of the selections.

15. A method comprising:
receiving a plurality of query requests from one or more user devices for respective queries;
based on the plurality of query requests and a click-through-rate (CTR)-based scoring model, conducting a plurality of searches to provide search results for each of the queries;
acquiring analytics data corresponding to the queries, wherein the analytics data includes (i) query files for the respective queries, and (ii) one or more selection files for each of the queries for which a selection event occurred, and wherein at least some of the selection events occur when a user of the one or more user devices selects a search result item in the search results provided for the queries;
determining a normalized CTR based on the analytics data;
updating the CTR-based scoring model based on the normalized CTR; and
conducting a search, subsequent to the plurality of searches, based on the updated CTR-based scoring model.

16. The method of claim 15, further comprising:
assigning search identifiers to the queries and corresponding search results;
transmitting the search results of the queries and the search identifiers to the one or more user devices;
based on the search identifiers, grouping the selection files corresponding to the queries; and
determining the normalized CTR based on, for each of the queries, a number of user selections of search result items provided in the corresponding search results.

17. The method of claim 15, further comprising:
assigning synthetic search identifiers to the query files and the selection files of the queries based on timestamps of the query files and the selection files;
based on the synthetic search identifiers, grouping the selection files corresponding to the queries; and
determining the normalized CTR based on, for each of the queries, a number of user selections of search result items provided in the corresponding search results.

18. The method of claim 17, further comprising:
determining whether the selection events are valid selection events, wherein
the selection events occur when a user of the one or more user devices provides a user input or click subsequent to one of the queries and prior to a next query after the one of the queries, and
an evaluated selection event is determined to be a valid selection event if the evaluated selection event has not occurred more than a predetermined amount of time after a timestamp of (i) a corresponding one of the query requests, (ii) a corresponding one of the query files, or (iii) another selection event; and
assigning the synthetic search identifiers to the valid selection events and not to invalid selection events.

19. The method of claim 15, further comprising:
normalizing a number of selections of search result items per query to 0 or 1; and
determining the normalized CTR based on (i) the normalized number of selections of search result items per query, and (ii) a total number of queries.

20. The method of claim 15, further comprising:
determining a non-normalized CTR; and
updating the CTR-based scoring model based on the non-normalized CTR.
